(19) United States
(12) Patent Application Publication
(10) Pub. No.: US 2011/0014460 A1
(43) Pub. Date: Jan. 20, 2011

(54) Conductive, EMI shielding and static dispersing laminates and method of making same

(76) Inventors: Arnis Kazakevics, Melbourne (AU); Peter Nicholas Binks, Victoria (AU); Larry Roy Jordan, Victoria (AU); Raviprasad Krishnamurthy, Victoria (AU); John Tivendale, Victoria (AU)

Correspondence Address: Charles N.J. Ruggiero;Ohlandt , Greeley, Ruggiero & Perle, L.L.P., 10th Floor, One Landmark Square, Stamford, CT, 06901-2682, US

(21) Appl. No.: 11/472,615

(22) Filed: Jun. 22, 2006

(51) Int. Cl. B32B 27/18; B05D 3/12; B32B 33/00

(52) U.S. Cl. 428/340; 427/369; 428/408; 977/892; 977/742

(57) ABSTRACT

A method of manufacturing a laminate is disclosed.

The method includes dispersing carbon nanotubes in a curable resin and then coating a semi-permeable substrate with this carbon nanotube containing resin. The coated semi-permeable substrate is pressed and the resin is at least partially cured, such that the carbon nanotubes are bound to the substrate. The carbon nanotubes are present in an amount between 0.1 wt % and 99 wt % in the at least partially cured resin.

### FIELD OF THE INVENTION

The present invention relates to conductive, electro-magnetic shielding and static dispersing laminates. More particularly the invention relates to laminates which may be applied to surfaces of articles or buildings and which demonstrate anti-static, static dissipative, electromagnetic interference (‘EMI”) shielding or electrically conductive properties. The invention also relates to methods of making such laminates.

### BACKGROUND OF THE INVENTION

Laminates, especially decorative laminates, having electrical conductive properties are known. Laminates having anti-static dissipative properties are generally useful as bench tops or flooring where it is essential to prevent electrostatic charging. For example, in workplaces involved with manufacture or processing of electronic components, laboratories or facilities where explosive or combustible atmospheres are present.

Laminates having electromagnetic shielding properties may be useful in the construction of floors, walls, partitions and ceilings of rooms or buildings where electromagnetic interference needs to be either kept out or retained within the room or building. For example, rooms housing sensitive medical imaging equipment, or working spaces where interference by telecommunications signals, or the ability of a third party to intercept a telecommunications transmission from outside the space, need shielding.

According to the US Department of Defense, the behaviour of conductive materials in respect of their ability to conduct electrostatic charges can be broken into the following categories based on surface electrical resistance in ohms/square:
Anti-static—greater than 10⁹
Dissipative—between 10⁶ and 10⁹
Conductive—less than 10⁶

The terms anti-static, dissipative and conductive as used in the description and claims of this specification shall generally refer to the above definitions. It will be appreciated however that there may be overlap between the respective ranges, for example a laminate may still be considered to have anti-static properties if it has a surface resistance in ohms/square of slightly less than 10⁹.

It would be desirable to provide laminates, such as high pressure, continuously pressed or low pressure decorative laminates with various degrees of conductivity which may have anti-static, dissipative, or electro-magnetic shielding properties. It would further be desirable to make such laminates without requiring significant capital expenditure on specialist plant or equipment.

### SUMMARY OF THE INVENTION

According to one aspect of the present invention, there is provided a method of manufacturing a laminate including the steps of:
(i) dispersing an amount of carbon nanotubes in a curable resin;
(ii) coating a semi-permeable substrate with the carbon nanotube containing resin;
(iii) pressing said coated semi-permeable substrate, and
(iv) at least partially curing said resin such that said carbon nanotubes are bound to said substrate and are present in an amount between 0.1 wt % and 99 wt % in said at least partially cured resin.

Preferably the curing step is performed when the coated substrate is being subjected to pressure. The pressure applied to the coated substrate may be suitable pressure capable of consolidating the resin layer with the semipermeable substrate, and more preferably capable of causing increased interconnection between adjacent carbon nanotubes. Preferably the pressure is in the range normally used in the manufacture of low pressure or high pressure decorative laminates, namely greater than about 15 bar specific pressure for low pressure laminates, up to 100 bar or more for high pressure laminates.

In another aspect of the invention, there is provided a laminate having anti-static properties, the laminate including
a semipermeable substrate coated with a resin containing between 0.1 wt % and about 4.0 wt % of carbon nanotubes in the at least partially cured resin, and wherein the coated substrate has been pressed and the resin is at least partially cured such that said carbon nanotubes are bound to said substrate.

In another aspect of the invention, there is provided a laminate having electrostatic dissipative properties, the laminate including
a semipermeable substrate coated with a resin containing between 0.1 wt % and about 30 wt % of carbon nanotubes in the at least partially cured resin, and wherein the coated substrate has been pressed and said resin is at least partially cured such that said carbon nanotubes are bound to said substrate.

In another embodiment of the invention there is provided a laminate having electromagnetic shielding properties, the laminate including a semipermeable substrate coated with a resin containing greater than about 3.5 wt % of carbon nanotubes in the at least partially cured resin, and wherein the coated substrate has been pressed and the resin is at least partially cured such that said carbon nanotubes are bound to said substrate.

The anti-static, dissipative and conductive laminates may further include a decorative layer which, when the laminate is in use, is preferably positioned outermost on the surface to which the laminate is applied, e.g. as a bench top, wall surface, etc. Preferably the decorative layer comprises a semipermeable sheet impregnated with a resin which is preferably pressed and cured with the substrate to bond the layers together.

Preferably, the resin in the anti-static, dissipative or conductive laminate includes a conductive salt, more preferably an organic salt such as sodium formate in order to decrease the resistance of the decorative layer. It is thought that organic salts are better compatible with preferred organic resins. Humectants may also be added to the resin in the decorative layer to enhance electrical conductivity. Where the laminate is an anti-static laminate, little or no salt is required in the resin of the decorative layer.

Where the laminate is a dissipative laminate, up to about 4 wt % may be included in the cured resin of the decorative layer.

Where the laminate is a conductive laminate, at least 4 wt % of salt may be required in the cured resin of the decorative layer where at least about 7% carbon nanotubes are used in the resin of the conductive layers.

Where the laminate is an electromagnetic interference shielding laminate, it is not necessary to include a decorative layer although this may be included. For the shielding properties to be achieved, adjacent sheets of laminate may have a conductive tape or other conductive medium applied with contacts between the conductive layers of 2 adjacent sheets or they may be electrically joined in other ways to ensure electrical continuity between the sheets.

Preferably, where the laminate is to be a low pressure laminate, the laminate is pressed at a specific pressure of greater than about 15 bar to about 40 bar.

Preferably, where the laminate is to be a high pressure laminate, the laminate is pressed at a specific pressure of greater than about 50 bar.

Both single walled and multi walled carbon nanotubes could be used. However, it is economically beneficial to use the multi walled nanotubes. Assuming the carbon nanotubes are multi walled carbon nanotubes (“MWNT's”), thin multi walled carbon nanotubes are most desirable. MWNT's have exhibited superior dispersion properties for a set loading in the resin systems preferred for making decorative laminates compared to single walled nanotubes. The MWNT's may be selected from crude MWNT's, purified MWNT's or functionalized MWNT's. Where the MWNT's are functionalized, they are preferably functionalized with an alkaline functional group, most preferably with a —NH₂ group prior to dispersion in the resin. This functionalised group being alkaline in nature is better suited for dispersion of nanotubes in the alkaline resins used in the present invention. An acidic functionalised group such as a —COOH group is likely to react with the resin and gives rise to undesirable precipitates.

Functionalized thin MWNT's are preferred for making EMI shielding laminates. Purified thin MWNT's are preferred for making conductive laminates.

Preferably the resins are resins conventionally used in the manufacture of decorative laminates especially high pressure laminates. Such resins may include melamine formaldehyde resins, phenol formaldehyde resins, urea formaldehyde resins and combinations of these resins and any derivatives of these resins as may be suitable for preparation of low pressure, continuously pressed and high pressure laminates. Other suitable resins or polymers that are compatible with formaldehyde-based resins may be used to incorporate carbon nanotubes in to the laminate.

The selected nanotubes are dispersed in a curable resin. The manner of dispersion and mixing may vary depending upon the type of nanotubes used, the loading amount of nanotubes to be dispersed into the resin, the type of resin and the viscosity of the resin/nanotube mix. In one embodiment, one or more surfactants may be added to the resin to assist in dispersion of the nanotubes.

In another embodiment, the resin may be diluted so as to decrease its viscosity when nanotubes are added thus to assist in dispersion. Where the resin is melamine formaldehyde, it may be diluted to about 50% by volume with water. Where the resin is phenol formaldehyde, it may be diluted to about 50% by volume with about 20% water or about 30% methanol/ethanol. It is desirable that the resin is first diluted with water/methanol/ethanol (depending upon the resin) before adding the carbon nanotubes to ensure adequate dispersion.

Mixing of the nanotubes in the resin may be achieved using a Speed™ mixer. A Speed™mixer is a mechanical mixer that rotates at a speed of 3000 rpm. An ultrasonic mixer, might also be used, and other means of mixing may equally be suitable.

Preferably the concentration of crude treated (not functionalized) carbon nanotubes in the resin is between 0.1 wt % and 33.3 wt %. A wet loading of up to 33.3 wt % may be achieved if the nanotubes are first mixed with a surfactant, then added to resin to which has been added diluant. The concentration of carbon nanotubes achieveable in the resin is thought to be dictated by the technique used for dispersing the tubes. While the Speed mixer is better for dispersing nanotubes up to a concentration of 9.1 wt. % in a resin, an Ultrasonic mixer has been found to be better for dispersing lower concentration of nanotubes up to 1 wt. % in a resin. However, ultrasonic mixer may be more effective in dispersing the nanotubes and for this reason dilution of resin by solvents may be preferable.

Preferably the amount of carbon nanotubes dispersed in the resin is less than the Precipitation Threshold. The Precipitation Threshold is the loading at which a sudden increase in conductivity was achieved. Methanol and ethanol on their own were found to be bad for dispersing nanotubes. Even 1 wt. % of MWNT in methanol could not be dispersed. However, in ethanol 1 wt. % of MWNT was better dispersed. Compared to these two, water was found to mix well with the nanotubes. However, adding melamine formaldehyde to nanotube+water mixture or phenolic resin to nanotube+ethanol mixture led to separation of phases. Hence, a surfactant was used to prevent water/ethanol coming directly in contact with the nanotubes. Thus the procedure described in the previous paragraph was followed to increase the loading of nanotubes in resin.

Preferably the semi-permeable substrate is a paper, more preferably a paper which is conventionally used in the manufacture of decorative high pressure laminates. For example, the paper may be an overlay paper having a weight of between 18 and 80 gsm although it could be any paper or substrate that can absorb resin and be pressed into a laminate. Semi-permeable substrates appear to allow for absorption of the carbon nanotube dispersed resin. Nanotubes appear to be trapped largely in the surface of the substrate while resin may be carried through the pores of the substrate which may give rise to a better conducting medium by forming a continuous/interconnected nanotube network in the surface layers of the substrate.

Paper such as over lay papers are normally made from cellulose pulp and contain small quantities of melamine formaldehyde resin or similar wet strength additives. These types of papers have sufficient wet strength to enable impregnation with formaldehyde based resins and when cured during lamination these papers tend to become relatively transparent. Often these papers are applied to the face of decorative laminates to protect the surface against wearing. Preferably the semi-permeable substrate is entirely saturated by the resin.

In another aspect of the invention, additives may be included in the uncured resin to further enhance the conductivity of the laminate. For example, metallic nanoparticles or fibres, or granules at the micron or submicron level may be added. Conductive metals such as copper or aluminium may be added if desired.

In a further aspect of the invention additional layers of resin impregnated sheets are laid over and/or under the conductive layer. Such laying-up of additional layers will be known to those skilled in the art of manufacture of low pressure and/or high pressure laminates.

It will now be convenient to describe the invention with reference to the following examples. The examples illustrate the manner in which the invention may be practiced, but it should be understood that the examples should not be considered limiting of the invention.

### EXAMPLES

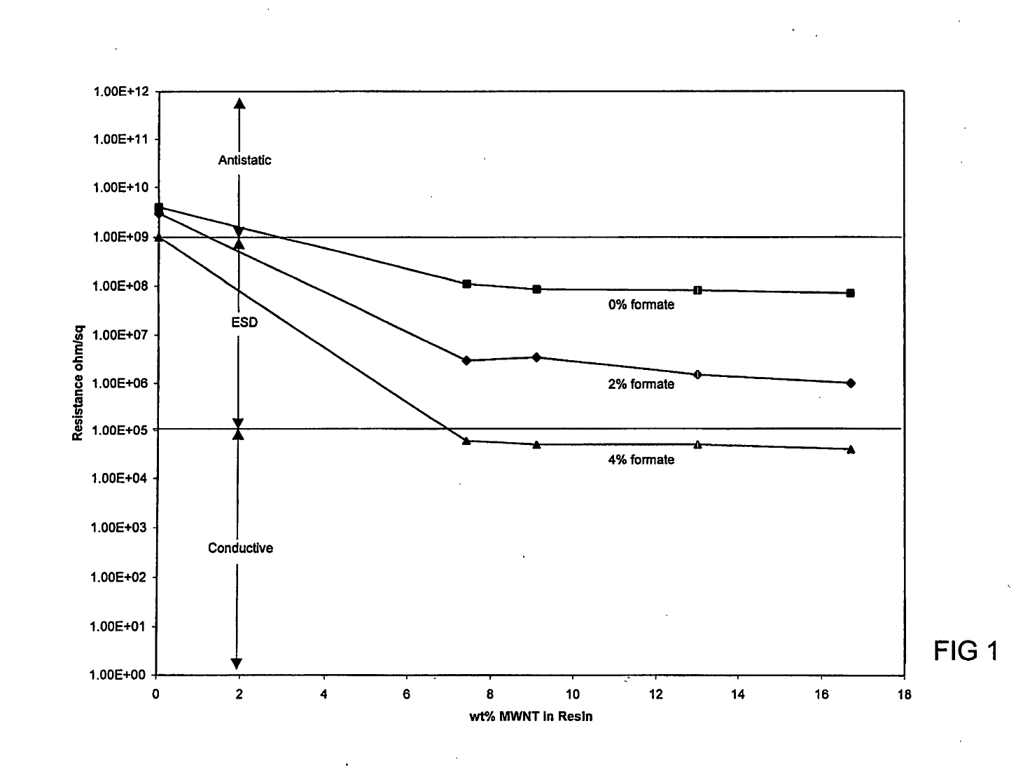

FIG. 1 is a graph of Resistance of Conductive overlay paper containing multi walled carbon nanotubes coating, with sodium formate added to resin in the decorative paper surface.

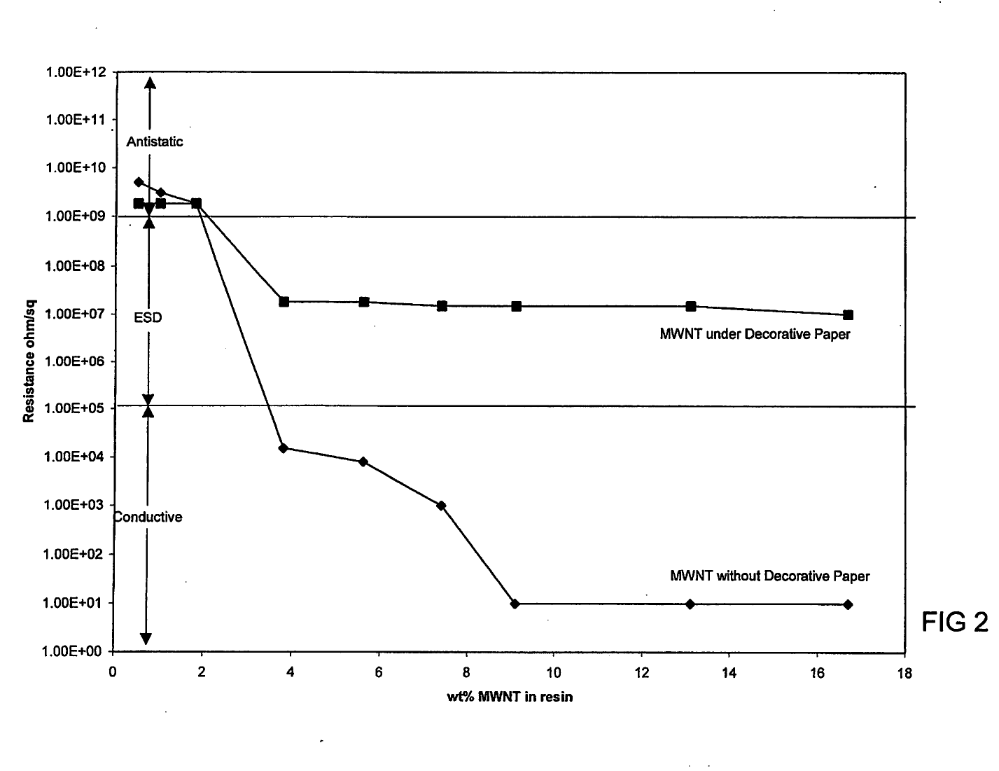

FIG. 2 is a graph of Resistance of Conductive overlay paper containing multi walled carbon nanotubes coating—with and without decorative surface paper.

### SELECTION OF NANOTUBES

The following types of carbon nanotubes were sourced from NanoCyl S.A, Namor, Belgium;
Thin MWNTs, crude, having a purity of greater than 80% and containing up to 20% metal oxides—alumina and iron oxide.
Thin MWNTs, purified, having a purity of greater than 95%
Thin MWNTs, —NH₂ functionalized.

Selection of Resins

The following resins were sourced from the applicant:
Melamine formaldehyde resin (M812)
Dosed melamine formaldehyde resin M812(MDE5)
Phenol formaldehyde resin (MSP6114)

Dispersion of Nanotubes in Resin

Each of the MWNT types was evaluated for its saturation point in resin.

The value of 33.3 wt. % of crude heated nanotubes in resin (before curing) was achieved as follows: to 0.1 g of MWNT, 5 g of a surfactant (dimethyl formamide) was added first to wet the surface of nanotubes completely with the surfactant. In a separate beaker, 0.2 g of resin was taken and to this diluent was added. This latter mixture is then poured into the beaker containing nanotubes and surfactant (again the sequence is important).

Thin MWNTs-NH2 functionalized, demonstrated good mixing resins producing (at a macro scale) homogeneous, non viscous, smooth mixtures at 9.1 wt % liquid MDE5 resin. At 16.7 wt % in the MDE5 resin the mixture became very viscous. The upper limit of MWNT loading in the liquid resin, without adding any solvent (e.g. water) to the resin is the range of ˜9-˜16 wt %. It may be possible to increase this MWNT wt %, or obtain a less viscous mixture at the same loading, by adding water to the resin.

9.1 wt % MWNT in the liquid resin corresponds to ˜16.7 wt % MWNT in the cured resin since the MDE5 contains ˜50 wt % water which is removed during drying.

Mixing MWNT-Resin Composites

Two methods of mixing were trialled: Mechanical mixing, using a Speed™Mixer (3000 rpm), and Ultrasonic Mixing using a Vibra Cell (Sonic) ultrasonic mixer 750 W.
Speed™Mixer Mechanical mixing was suitable for producing mixtures of MWNT across a wide concentration range. However, the mechanical mixer did not appear to disperse the nanotubes well, as aggregates could be seen when even low wt % MWNT-NH2 were coated onto paper. At high MWNT wt % mixing, as opposed to dispersion, of the nanotubes may be suitable.
UltraSonic Mixer The ultrasonic mixer was suitable for dispersing low wt % loadings up to ˜2 wt %. At higher loadings the ultrasonic mixer tended to make the mixtures very viscous, possibly by heating inducing partial curing of the resin. At low wt % loadings the ultrasonic mixer produced very well dispersed samples with no aggregates noticeable when coating onto paper.
Use of Dispersion agents (surfactants) It was possible to partially disperse MWNT crude with a dispersion agent (dodecylbenzene sulfonate), but the mixture still consisted of large particles. Dimethyl formamide as a surfactant was found to be better suited for dispersing increased loading of nanotubes in resin.

Preparation of Test Materials

Aqueous Resin Solutions

The solvent content (water and methanol) in the liquid resin (approximately 50% water in melamine formaldehyde and 20% and 30% methanol in phenol formaldehyde) is considered desirable compared with resins with an increased solids content as it enables the concentration of MWNT and the viscosity of the mixture to be kept low during mixing which makes mixing, dispersion and application easier, especially if the loading requirement of MWNT in the cured resin needs to be higher.

It is possible to add more water to melamine formaldehyde resins. More water could be added to phenol formaldehyde resins if the alkalinity of the resin was increased. The limits of water addition were determined by adding water to the M812 and MDE5 resins until the resin turned white due to precipitation of the resin.

Approximately 80% water can be added to the M812 resin and approximately 30% to the MDE5 resin before the resin started to precipitate. At these water addition rates it may be possible to nearly double the wt % of MWNT added to the M812 and increase the wt % added to the MDE5 by a third, or alternatively decrease viscosity of the liquid resin mixture while keeping the same MWNT wt % in the cured resin. If more water is added and the resin precipitates, it redissolves again during drying—so may not have a permanent effect on the resin properties. In production of high pressure laminate approximately 10 wt % water is added to the resin bath to reduce resin viscosity. It is not desirable to add too much more water to the resin in the current inventive production process as it makes the paper weaker and requires additional drying.

Preparation and Evaluation of Paper Conductivity

Conductivity Test Samples

Nine strips of 120×20 mm of 32 gsm overlay paper were coated with thin MWNTs-NH2 functionalized in MDE5 resin which were mixed in to the resin for 5 minutes using a Speed™Mixer then coated onto a sheet of 32 gsm overlay paper at a loading of approximately 132 gsm (MWNT contents in cured resin from 0.5 to 16.7 wt %) have been fabricated for conductivity testing. The strips were hot pressed at a temperature of 140° C., and specific pressure of 70 bar onto the front of the laminate composite with half of the strip covered with a sheet of decorative paper.

Testing of Surface Resistance

The conductivity of the MWNT-overlay paper achieved, after hot pressing, can be reduced to approximately 0Ω at a MWNT loading of 9 wt %. This provides a level of resistance broadly suitable for either electronic dissipation (“ESD”) or electromagnetic interference (“EMI”) shielding.

Surface Point-to-Point Conductivity of MWNT Coated Overlay Paper

Surface resistance was measured using a Megger®BM10 resistance meter. A layer of decorative paper over the MWNT-overlay paper significantly increases the resistance making it unsuitable for ESD protection unless said decorative paper contains conductive materials in the resin such as sodium formate. EMI shielding is not affected by insulating materials on top of the conductive layer, so the effect of the decorative overlay is not relevant to EMI shielding.

Fabrication of Laminates

Preparation of Lab Scale Laminates

EMI test samples Two 170×170 mm samples of conductive HPL have been fabricated for EMI shielding testing. The samples contain thin MWNTs-NH2 functionalized in the MDE5 resin which were mixed into the resin for 5 minutes using a Speed™Mixer 5 minutes then coated onto a layer of 32 gsm overlay paper at a loading of approximately 132 gsm (MWNT contents in cured resin 8.7 and 16.7 wt %). The MWNT coated overlay paper was hot pressed at a temperature of 140° C. and Specific Pressure of 70 bar onto the back of a laminate composite.

The following build was assembled to make a high pressure decorative laminate for EMI shielding:

1. decorative paper sheet impregnated with melamine formaldehyde resin, face up

2. 155 gsm barrier kraft paper impregnated with standard grade phenol formaldehyde resin

3. 160 gsm kraft paper impregnated with post form grade phenol formaldehyde resin

4. 160 gsm kraft paper impregnated with post form grade phenol formaldehyde resin

5. 160 gsm kraft paper impregnated with post form grade phenol formaldehyde resin

6. conductive barrier sheet (32 gsm overlay paper impregnated with melamine formaldehyde resin containing nanotubes), face down.

The build is then cured at a temperature of 140° C. and Specific Pressure of 70 bar.

It is to be understood that various modifications, additions and/or alterations may be made to the process previously described without departing from the present invention.

1. A method of manufacturing a laminate including the steps of:
(i) dispersing an amount of carbon nanotubes in a curable resin;
(ii) coating a semi-permeable substrate with the carbon nanotube containing resin;
(iii) pressing said coated semi-permeable substrate, and (iv) at least partially curing said resin such that said carbon nanotubes are bound to said substrate and are present in an amount between 0.1 wt % and 99 wt % in said at least partially cured resin.

2. The method of claim 1, wherein the step of at least partially curing the resin is performed while subjecting the coated substrate to sufficient pressure to consolidate the resin layer with the semi-permeable substrate.

3. The method of claim 2, wherein said pressure is sufficient to cause increased interconnection between adjacent carbon nanotubes.

4. The method of claim 2, wherein said pressure is greater than 15 bar specific pressure.

5. The method of claim 1, wherein said resin includes a conductive salt.

6. The method of claim 5, wherein said conductive salt is an organic salt.

7. The method of claim 1, wherein said carbon nanotubes are multi walled carbon nanotubes (“MWNT's”).

8. The method of claim 7, wherein said MWNT's are thin MWNT's selected from functionalised MWNT's and non-functionalised MWNT's comprising crude MWNT's and purified MWNT's.

9. The method of claim 8, wherein said functionalised MWNT's are functionalised with an alkaline functional group, prior to being dispersed in said resin.

10. The method of claim 1, wherein said curable resin also includes one or more surfactants to assist in the dispersion of the nanotubes therein.

11. The method of claim 1, wherein a diluent is added to said resin prior to addition of said nanotubes, said diluent comprising water, methanol and/or ethanol.

12. The method of claim 1, wherein the amount of carbon nanotubes dispersed in the resin is less than a Precipitation Threshold.

13. The method of claim 8, wherein the concentration of non-functionalised MWNT's in the resin is between 0.1 wt % and 33.3 wt %.

14. The method of claim 1, wherein said semi-permeable substrate is a paper suitable for use in manufacture of high pressure laminates.

15. The method of claim 14, wherein the paper is an overlay paper having a weight of between 18 and 80 gsm.

16. The method of claim 1 wherein the curable resin includes a conductivity enhancing additive.

17. The method of claim 16, wherein the conductivity enhancing additive comprises metallic nanoparticles, fibres or granules at the micron or submicron level.

18. The method of claim 17, wherein said metallic nanoparticles, fibres or granules comprise copper or aluminium.

19. A laminate comprising:
a semipermeable substrate coated with a resin comprising at least 0.1 wt % carbon nanotubes, wherein the substrate is coated and wherein the coated substrate has been pressed and said resin is at least partially cured such that said carbon nanotubes are bound to said substrate.

20. The laminate of claim 19, wherein said resin comprises between 0.1 wt % and about 4.0 wt % carbon nanotubes and wherein said laminate has anti-static properties.

21. The laminate of claim 19, wherein said resin comprises between 0.1 wt % and about 30 wt % of carbon nanotubes and wherein said laminate has electrostatic dissipative properties.

22. The laminate of claim 19, wherein said resin comprises greater than about 3.5 wt % of carbon nanotubes and wherein said laminate has electromagnetic shielding properties.

23. The laminate of claim 19, further including an outermost decorative layer pressed, cured and bonded to said semipermeable substrate.

24. The laminate of claim 23, wherein the cured resin of the decorative layer includes up to about 4 wt % of a conductive salt.

25. The laminate of claim 23, wherein the cured resin of the decorative layer includes at least 4 wt % of a conductive salt when the semipermeable substrate contains at least about 7% carbon nanotubes.

26. The laminate of claim 25, wherein said conductive salt is an organic salt.

27. The laminate of claim 19 wherein said laminate comprises a low pressure laminate which has been pressed at a specific pressure of greater than about 15 bar to about 40 bar.

28. The laminate of claim 19, wherein said laminate comprises a high pressure laminate which has been pressed at a specific pressure of greater than about 50 bar.

29. The laminate of claim 19, wherein said carbon nanotubes are multi walled carbon nanotubes (“MWNT's”).

30. The laminate of claim 19, wherein said carbon nanotubes are thin multi walled carbon nanotubes (MWNT's) selected from functionalised MWNT's and non-functionalised MWNT's comprising crude MWNT's and purified MWNT's.

31. The laminate of claim 30 wherein said functionalised MWNT's are functionalised with an alkaline functional group prior to being dispersed in said resin.

32. The laminate of claim 19 wherein the amount of carbon nanotubes dispersed in the resin is less than a precipitation threshold.

33. The laminate of claim 30, wherein the concentration of non-functionalised MWNT's in the resin is between 0.1 wt % and 33.3 wt %.

34. The laminate of claim 19, wherein said semi-permeable substrate is a paper suitable for use in manufacture of high pressure laminates.

35. The laminate of claim 34, wherein the paper is an overlay paper having a weight of between 18 and 80 gsm.

36. The laminate of claim 19 wherein the curable resin includes a conductivity enhancing additive selected from metallic nanoparticles, fibres or granules at the micron or submicron level.

37. The laminate of claim 36 wherein said metallic nanoparticles, fibres or granules comprise copper or aluminium.

38. A laminate manufactured by the method of claim 1.

39. The method of claim 6, wherein said organic salt is sodium formate.

40. The laminate of claim 26, wherein said organic salt is sodium formate.

41. The method of claim 9, wherein said alkaline functional group is an —NH₂ group.

42. The laminate of claim 31, wherein said alkaline functional group is an —NH₂ group.

43. The laminate of claim 26, wherein said outermost decorative layer comprises a semipermeable sheet impregnated with a resin.
